(19) United States
(12) Patent Application Publication
(10) Pub. No.: US 2015/0123862 A1
(43) Pub. Date: May 7, 2015

(54) WAVEGUIDE TO PARALLEL-PLATE TRANSITION AND DEVICE INCLUDING THE SAME

(71) Applicant: ThinKom Solutions, Inc., Torrance, CA (US)

(72) Inventors: William MILROY, Torrance, CA (US); Alan C. LEMONS, San Pedro, CA (US)

(73) Assignee: ThinKom Solutions, Inc., Torrance, CA (US)

(21) Appl. No.: 14/073,990

(22) Filed: Nov. 7, 2013

(51) Int. Cl. H01Q 19/13; H01Q 21/00

(52) U.S. Cl. CPC H01Q 19/138; H01Q 21/0006
USPC 343/776; 343/780

(57) ABSTRACT

A waveguide to parallel-plate transition is provided which includes a waveguide, an E-plane waveguide bend, an H-plane waveguide bend and a parallel-plate transmission line arranged in sequence. The E-plane waveguide bend is configured to bend a direction of a radio frequency (RF) field between the waveguide and the H-plane waveguide bend by approximately 90 degrees in an E-plane. The H-plane waveguide bend is configured to bend a direction the RF field between the E-plane waveguide bend and the parallel-plate transmission line by approximately 90 degrees in an H-plane, and the parallel-plate transmission line includes a slot through which the RF field can flow between the H-plane waveguide bend and the parallel-plate transmission line.

### TECHNICAL FIELD

The following relates generally to electromagnetic waveguide couplers, and more specifically to waveguide to parallel-plate transmission line transitions. Moreover, the following relates to devices including the same.

### BACKGROUND

Radio frequency (RF) devices oftentimes employ one or more electromagnetic waveguides (also referred to herein as a ‘waveguide’ or ‘waveguides’) through which high-frequency electromagnetic waves may propagate. Frequently these devices require a transition from a waveguide to a parallel-plate transmission line (also referred to herein as a ‘parallel-plate’). Such a transition may be complicated due to an increasing desire for overall miniaturization.

For example, planar (and other types of) antenna systems often require the antenna to fit into ever-shrinking available spaces while maintaining key performance characteristics including high ohmic efficiency and wide operating bandwidth. To achieve the desired performance, a hybrid combination of parallel-plate and waveguide are often used as propagation media in the antenna design due to their superior bandwidth and ohmic efficiency characteristics. To save space and reduce the thickness profile, the transition between the antenna feed and the radiating aperture is usually deployed in a plane parallel or coincident with the radiating aperture. This places constraints on the transition between the feed and the radiating aperture.

The waveguide portion of the hybrid combination is usually deployed in a corporate feed, traveling-wave feed, standing-wave feed, or other structure where multiple outputs are coupled to a common parallel-plate. To support the hybrid combination, there must be a coupling transition between the two media. Typical transitions include waveguide-to-coaxial transmission line transitions, waveguide twist sections, waveguide transformer sections or a combination of these approaches. Each of these approaches has its drawbacks either in terms of reduced efficiency, reduced bandwidth, added height profile, added design complexity or added manufacturing complexity.

A common practice for coupling RF power between waveguide and parallel-plate is through an electromagnetic slot (also referred to herein as a ‘slot’). For example, a rectangular waveguide may include a slot within its broadwall normal to the propagation axis of the waveguide. RF energy from the waveguide exits the slot and is introduced into the parallel-plate, or vice versa, via a corresponding slot or other aperture. As another example, a rectangular waveguide may include a slot within its narrow wall at an angle parallel to the propagation axis. Again, RF energy may exit the slot and is introduced into the parallel-plate, or vice versa. As still another example, the rectangular waveguide may include a slot in the broadwall or narrow wall rotated at an angle relative to the propagation axis.

While such approaches may be thin in height profile, in a practical case where multiple waveguides with slots in their broadwall are used to feed a parallel-plate, feeding these waveguides may be a challenge in the available space (usually confined to the foot print of the parallel-plate) due to their close spacing. In a case where multiple waveguides with slots in their narrow wall are utilized so as to increase the spacing between the waveguide and parallel-plate, short circuit boundary conditions between corresponding slots within the parallel-plate may result in the waveguide coupling only a negligibly small amount of power into the parallel-plate—rendering this approach highly inefficient and therefore impractical to implement. The efficiency problem with this approach may be addressed by adding a waveguide twist between the slot and the waveguide that rotates the slot by 90 degrees, however, this implementation will add undesired height to the transition while the waveguide twist design may further serve to reduce operating bandwidth and increase manufacturing complexity.

In view of the aforementioned shortcomings associated with conventional transitions between waveguide and parallel-plate, there is a strong need in the art for a waveguide to parallel-plate transmission line transition that maintains efficiency and bandwidth in a compact space.

### SUMMARY

According to an aspect, a waveguide to parallel-plate transition is provided which includes a waveguide, an E-plane waveguide bend, an H-plane waveguide bend and a parallel-plate transmission line arranged in sequence. The E-plane waveguide bend is configured to bend a direction of a radio frequency (RF) field between the waveguide and the H-plane waveguide bend by approximately 90 degrees in an E-plane. The H-plane waveguide bend is configured to bend a direction the RF field between the E-plane waveguide bend and the parallel-plate transmission line by approximately 90 degrees in an H-plane, and the parallel-plate transmission line includes a slot through which the RF field can flow between the H-plane waveguide bend and the parallel-plate transmission line.

According to an aspect, the waveguide is aligned parallel to the parallel-plate transmission line.

According to another aspect, the transition further includes a waveguide tuning network interposed between the waveguide and the E-plane waveguide bend.

According to another aspect, the waveguide tuning network includes a step in a broadwall dimension and a step in a narrow wall dimension of the waveguide.

According to still another aspect, the waveguide tuning network includes a circular waveguide stub in a wall of the waveguide.

According to another aspect, the E-plane waveguide bend includes at least one chamfer in a waveguide broad wall.

According to yet another aspect, the H-plane waveguide bend includes at least one step along a waveguide narrow wall.

According to another aspect, a device is provided which includes at least two waveguide to parallel-plate transitions as described herein, each including the same parallel plate transmission line, wherein the parallel-plate transitions are arranged with the waveguide of each of the at least two waveguide to parallel-plate transitions parallel to one another.

According to another aspect, the waveguide of each of the at least two waveguide to parallel-plate transitions are aligned parallel to the parallel-plate transmission line.

According to still another aspect, a device is provided which includes at least two waveguide to parallel-plate transitions as described herein; and at least one “Y”-shaped waveguide arranged to join together the waveguides of each of the at least two waveguide to parallel-plate transitions.

The following description and the annexed drawings set forth in detail certain illustrative embodiments. These embodiments are indicative, however, of but a few of the various ways in which the principles may be employed. Other objects, advantages and novel features will become apparent from the following detailed description when considered in conjunction with the drawings.

### BRIEF DESCRIPTION OF DRAWINGS

In the annexed drawings, like references indicate like parts or features:

FIGS. 1A-1E are isometric views (FIGS. 1A-1D) and a transparent isometric view (FIG. 1E) of waveguide to parallel-plate transition according to a first embodiment described herein.

FIGS. 2A-2D are isometric views of waveguide to parallel-plate transition according to a second embodiment described herein.

FIGS. 3A-3D are isometric views of waveguide to parallel-plate transition according to a third embodiment described herein.

FIG. 4 is a schematic block diagram representing a waveguide to parallel-plate transition as described herein.

FIG. 5 is a transparent isometric view of a multiple waveguide to parallel plate transition arrangement feeding a parallel plate.

FIG. 6 is a transparent isometric view of two waveguide to parallel plate transitions with a common Y-shaped feed.

FIG. 7 is a transparent isometric view of an arrangement of a multiple waveguide to parallel plate transition with common Y-shaped feed arrangement feeding a parallel plate.

### DETAILED DESCRIPTION

A waveguide to parallel-plate transition as described herein achieves a transition between a waveguide and a parallel-plate transmission line in a compact space while maintaining high ohmic efficiency and wide bandwidth. The transition combines an electromagnetic waveguide H-plane bend (also referred to herein as an ‘H-plane waveguide bend’), an electromagnetic waveguide E-plane bend (also referred to herein as an ‘E-plane waveguide bend), and a slot to form a transition between the waveguide and the parallel-plate transmission line.

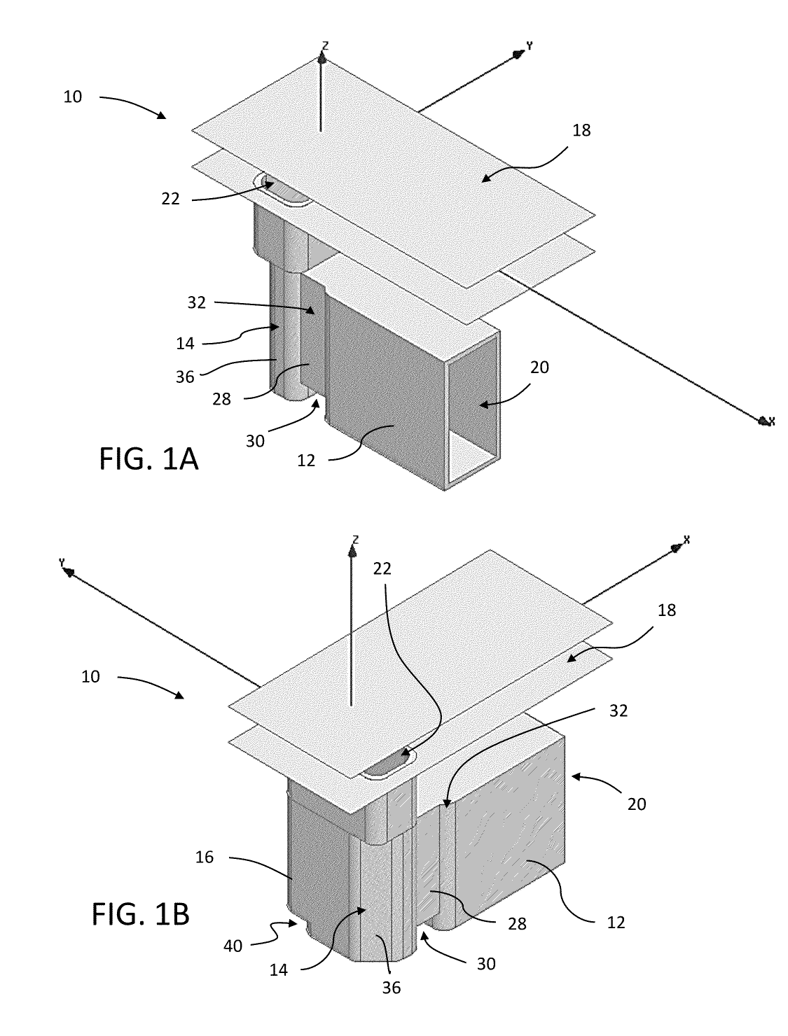

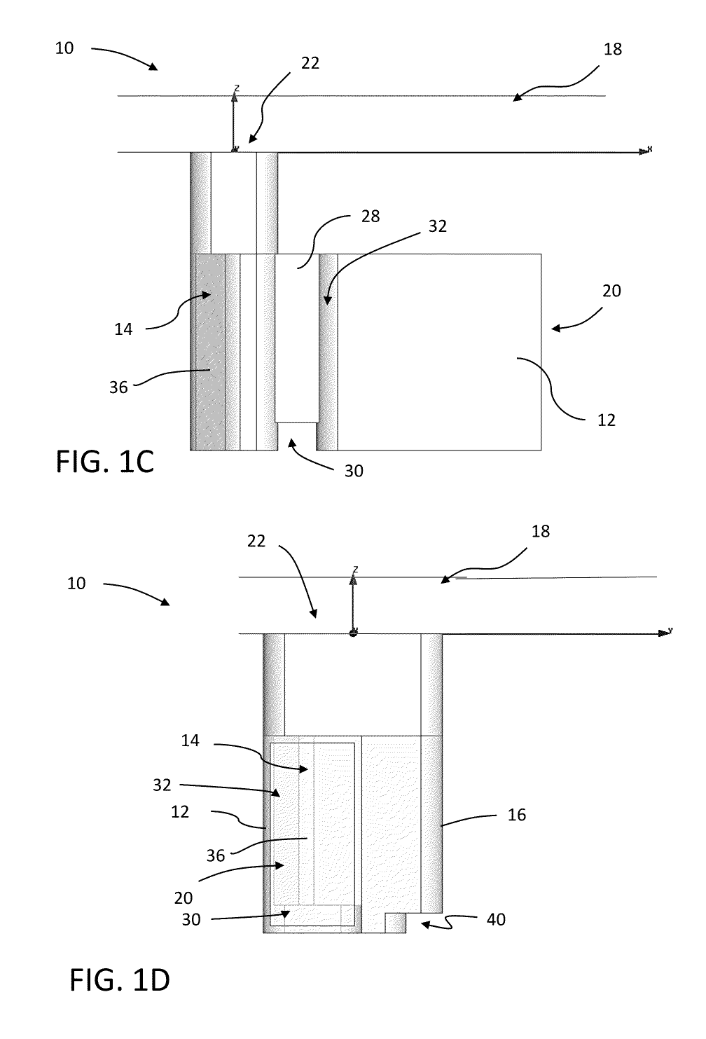

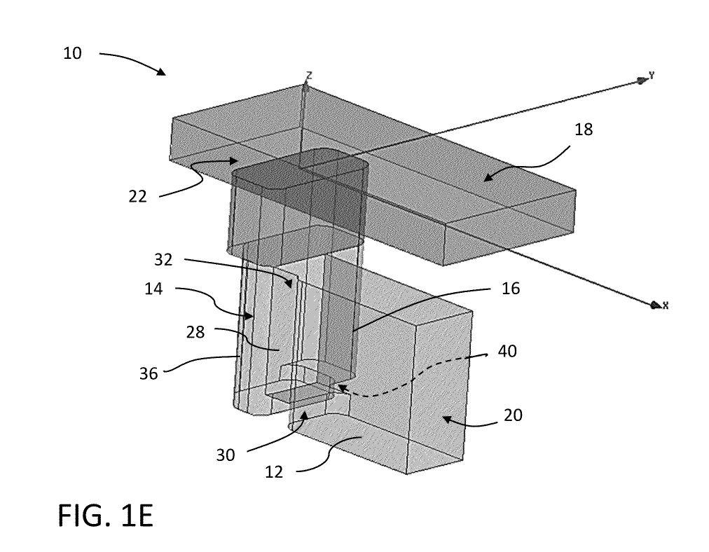

Referring initially to FIGS. 1A-1E, shown is a waveguide to parallel-plate transition 10 according to an exemplary embodiment. The waveguide to parallel-plate transition 10 includes a waveguide 12, an E-plane waveguide bend 14, an H-plane waveguide bend 16 and a parallel-plate transmission line 18 arranged in sequence. The waveguide 12 includes a port 20 and the parallel-plate transmission line 18 includes a slot 22, each through which a radio frequency (RF) field may travel.

The E-plane waveguide bend 14 is configured to bend a direction of the RF field between the waveguide 12 and the H-plane waveguide bend 16 by approximately 90 degrees in an E-plane. The H-plane waveguide bend 16 is configured to bend a direction the RF field between the E-plane waveguide bend 14 and the parallel-plate transmission line 18 by approximately 90 degrees in an H-plane. (As referred to herein, ‘approximately 90 degrees’ refers to 90 degrees±30 degrees.) The parallel-plate transmission line 18 includes a slot 22 through which the RF field can flow between the H-plane waveguide bend 16 and the parallel-plate transmission line 18.

RF energy which is introduced into the port 20 will consequently be redirected in the E-plane by 90 degrees, and subsequently redirected in the H-plane by 90 degrees before entering the slot 22 into the parallel-plate transmission line 18. Conversely, RF energy which is introduced into the slot 22 from the parallel-plate transmission line 18 is redirected in the H-plane by 90 degrees and subsequently redirected in the H-plane by 90 degrees before exiting through the waveguide port 20.

In a configuration as shown, the waveguide 12 may be aligned parallel to the parallel-plate transmission line 18. It is possible to achieve efficiency and bandwidth while maintaining a compact space. For improved performance, the waveguide to parallel-plate transition 10 includes an optional waveguide tuning network 28 interposed between the waveguide 12 and the E-plane waveguide bend 14.

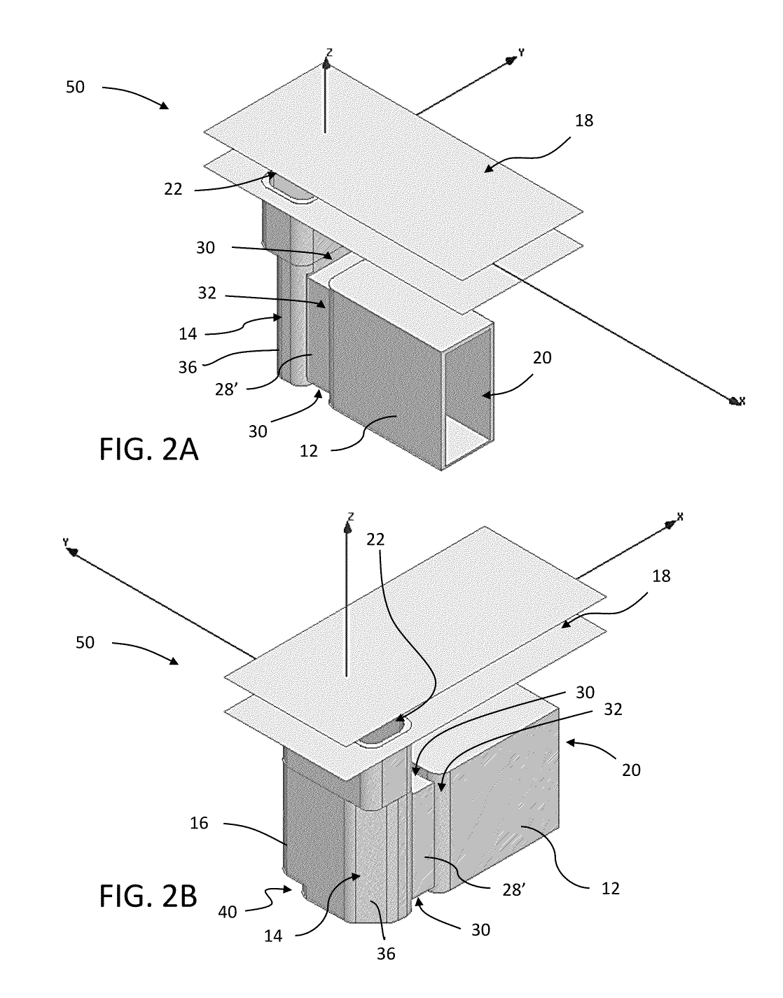

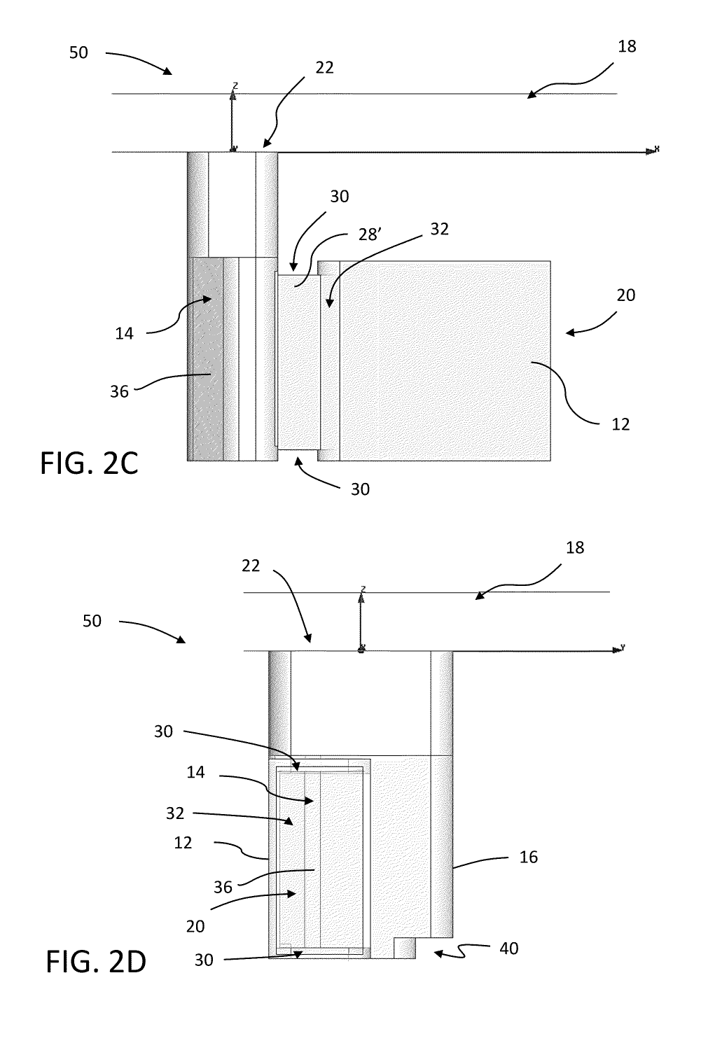

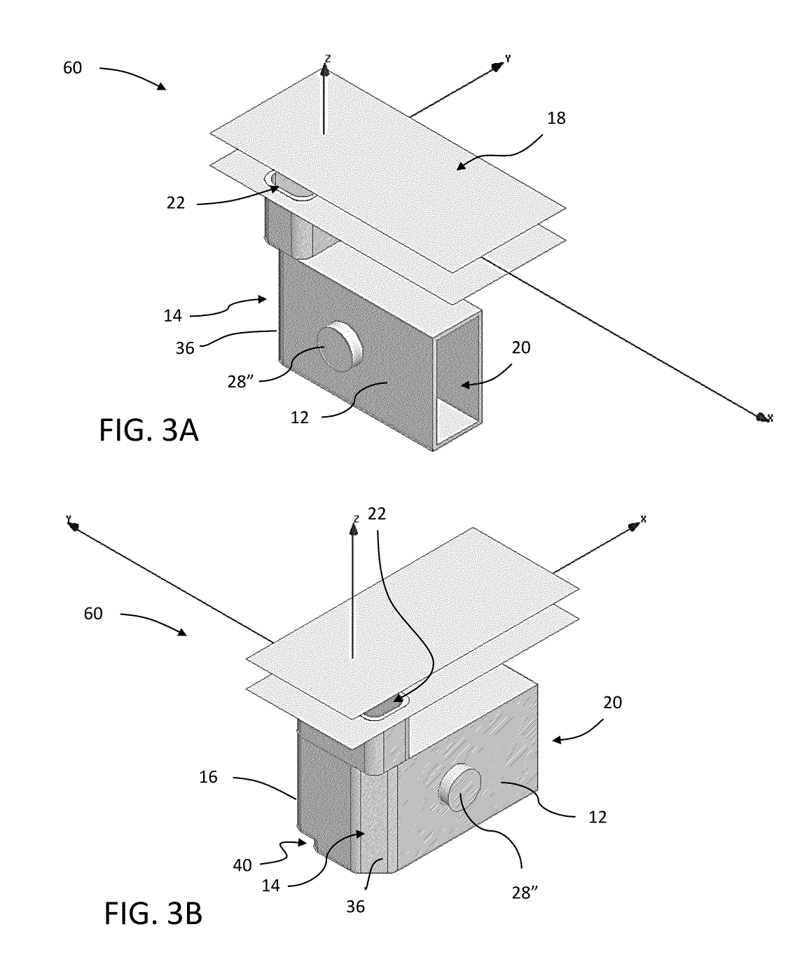

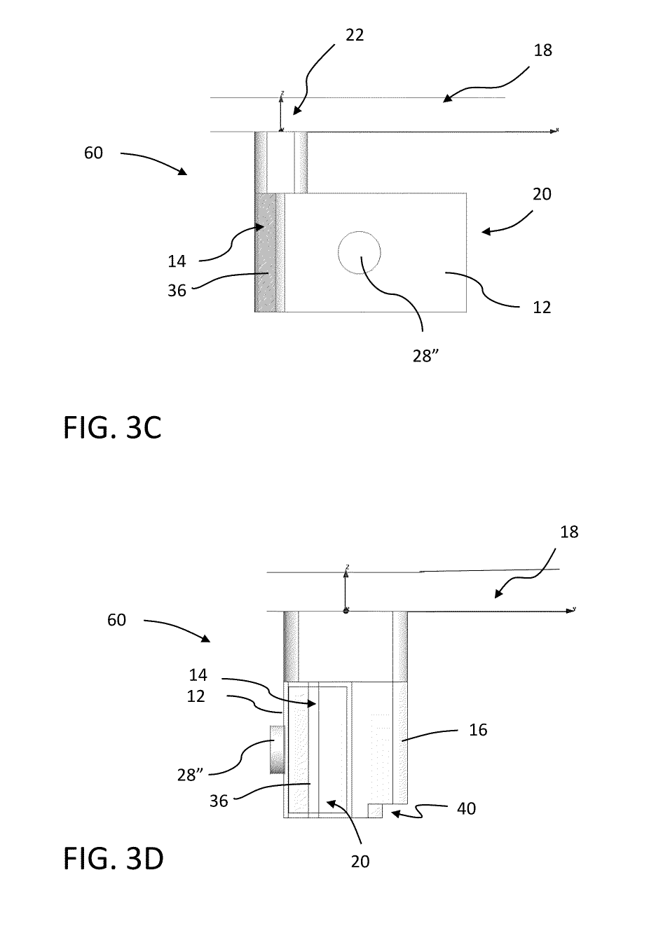

In the embodiment of FIGS. 1A-1E, the waveguide tuning network 28 is asymmetric and includes a step 30 in a broadwall dimension and a step 32 in a narrow wall dimension of the waveguide 12. The precise dimensions of the steps 30 and 32 will depend on the operating frequency, etc., as will be appreciated. The dimensions may be determined using known techniques via modeling software, empirical design, etc. Therefore, further detail is omitted for sake of brevity. It will be appreciated by those of ordinary skill in the art that a variety of other types of waveguide tuning networks may be used in place of the waveguide tuning network 28 without departing from the scope herein. (See below the discussion of the embodiments of FIGS. 2A-2D and 3A-3D).

The E-plane waveguide bend 14 includes at least one chamfer 36 in a waveguide broad wall. The chamfer 36 is designed to turn an RF field within the waveguide by approximately 90 degrees in the E-plane. The particular dimensions of such chamfer 36 may be determined similarly using known techniques via modeling software, empirical design, etc. Therefore, further detail is omitted for sake of brevity. Those having ordinary skill in the art will also appreciate that other known forms of an E-plane waveguide bend may be used in place of a chamfer formed in the broad wall. For example, a standard E-plane waveguide bend having a 90 degree continuous curvature along the E-plane of the waveguide is equally suitable. The chamfer 36 may be preferable to a continuous curvature, on the other hand, as the 90 degree bend may be completed in a more compact amount of space.

The H-plane waveguide bend 16 includes at least one step 40 along a waveguide narrow wall. The step 40 is designed to turn an RF field within the waveguide by approximately 90 degrees in the H-plane. The particular dimensions of the step 40 may be determined similarly using known techniques via modeling software, empirical design, etc. Therefore, further detail is omitted for sake of brevity. Those having ordinary skill in the art will also appreciate that other known forms of an H-plane waveguide bend may be used in place of a step formed in the narrow wall. For example, a standard H-plane waveguide bend having a 90 degree continuous curvature along the H-plane of the waveguide is equally suitable. The step 40 may be preferable to a continuous curvature, on the other hand, as the 90 degree bend may be completed in a more compact amount of space.

FIGS. 2A-2D illustrate a waveguide to parallel-plate transition 50 according to another embodiment. The waveguide to parallel-plate transition 50 is identical in relevant part to the embodiment of FIGS. 1A-1E with the exception of utilizing an alternative waveguide tuning network 28′. The waveguide turning network 28′ in this embodiment is symmetric in that it includes a step 30 in a broadwall dimension on each of opposite sides of the waveguide 12, and a step 32 in a narrow wall dimension on each of opposite sides of the waveguide 12.

FIGS. 3A-3D illustrate a waveguide to parallel-plate transition 60 according to another embodiment. The waveguide to parallel-plate transition 60 again is identical in relevant part to the embodiment of FIGS. 1A-1E with the exception of the waveguide stub type tuning network 28″ is made up of a circular waveguide stub in a wall of the waveguide. In this case, the stub is included in the broad wall of the waveguide 12. As will be appreciated by those of ordinary skill in the art, a variety of different types of waveguide tuning networks may be utilized without departing from the scope herein.

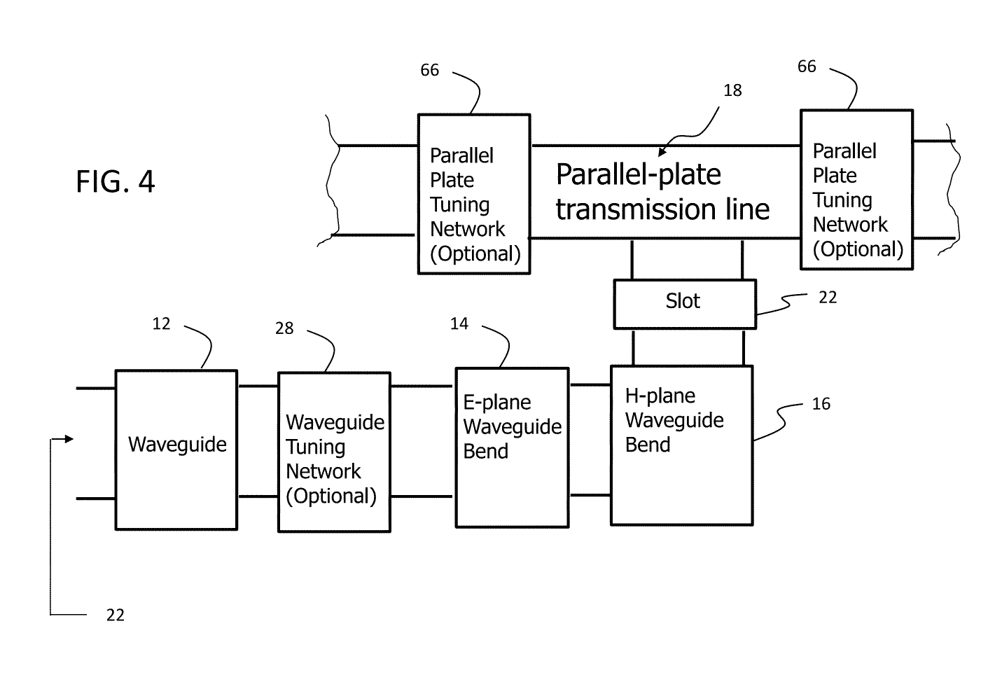

FIG. 4 is a schematic block diagram of a waveguide to parallel-plate transition as described herein. As previously described, the waveguide to parallel-plate transition includes the waveguide 12, the waveguide tuning network 28 (optional), the E-plane waveguide bend 14, and the H-plane waveguide bend 16 and the parallel-plate transmission line 18 arranged in sequence. The waveguide 12 includes the port 20 and the parallel-plate transmission line 18 includes the slot 22, each through which a radio frequency (RF) field may travel. Each of these components may be made up of a known component of such type. The waveguide 12 may be any of several types of known waveguides, the tuning network 28 can be any of several types of known waveguide tuning networks, the E-plane waveguide bend 14 can be any of several types of known E-plane waveguide bends, and the H-plane waveguide bend 16 may be any of several types of known H-plane waveguide bends. Similarly, the parallel-plate transmission line 18 may be any of several different types of known parallel-plate transmission lines. As yet another option, the parallel-plate transmission line 18 may include one or more parallel-plate tuning networks 66. Again, the parallel-plate tuning networks 66 may be any of several different types of known parallel-plate tuning networks. Accordingly, additional detail is omitted for sake of brevity.

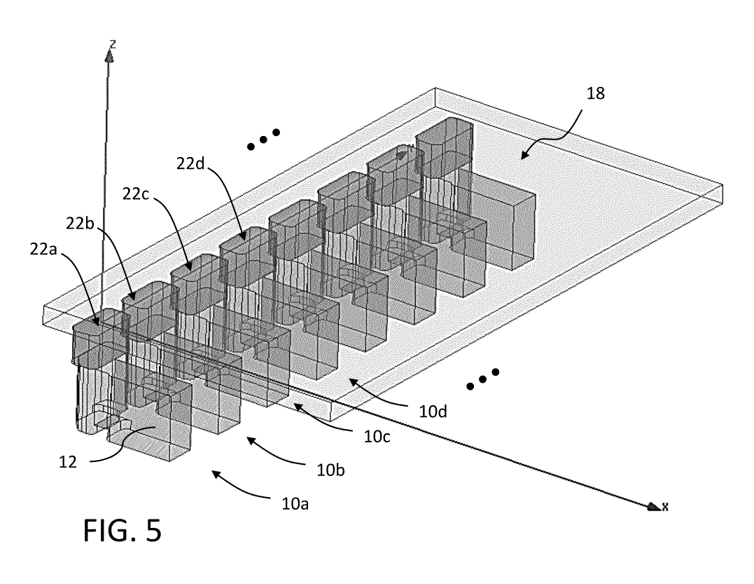

FIG. 5 illustrates a device which includes two or more waveguide to parallel-plate transitions 10 (e.g., 10a, 10b, . . . ) arranged to feed the same parallel plate transmission line 18. Due to their design, the waveguide to parallel-plate transitions 10 are able to be spaced close to one another with the waveguide 12 of each transition 10 arranged parallel to one another. This allows the slots 22 (e.g., 22a, 22b, . . . ) to be placed close to one another so as to feed the parallel-plate transmission line 18 in an array. At the same time, the waveguide 12 of each of the waveguide to parallel-plate transitions 10 may be aligned parallel to the parallel-plate transmission line 18. These features provide compactness in the array while maintaining efficiency and bandwidth.

FIG. 5 includes two or more waveguide to parallel-plate transitions 10 as shown in the embodiment of FIGS. 1A-1E. However, it will be appreciated that the arrangement may include two or more of any of the embodiments discussed herein.

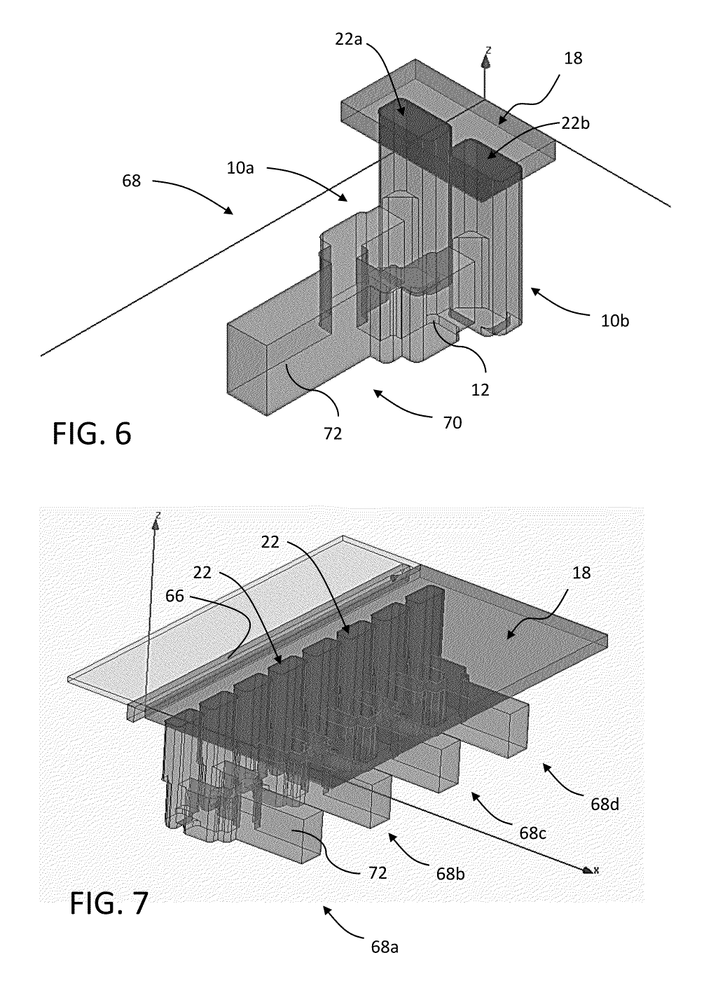

FIG. 6 illustrates a device 68 in which two or more waveguide to parallel-plate transitions 10 (e.g., 10a, 10b) are together joined by a “Y”-shaped waveguide 70. For example, the waveguide 12 of each of waveguide to parallel-plate transitions 10a and 10b are joined to a corresponding branch of the “Y”-shaped waveguide 70. In this way, the waveguide to parallel-plate transitions 10 may be fed by a common branch 72 of the “Y”-shaped waveguide 70. The corresponding slots 22 (e.g., 22a, 22b) may then be used to feed the parallel-plate transmission line 18 in a compact design. Again, it will be appreciated that the arrangement of FIG. 6 may utilize two or more waveguide to parallel-plate transitions according to any of the embodiments discussed herein.

FIG. 7 illustrates an array of devices 68 (e.g., 68a-68d) in accordance with that shown in FIG. 6. The devices 68 are arranged to feed the same parallel-plate transmission line 18. As a result of this configuration, N slots 22 (where N is an even integer and N≧2) may be fed using only N/2 waveguides 72. This reduces cost, complexity, etc. Further, the parallel-plate transmission line 18, as in all of the embodiments described herein, may include a parallel-plate tuning network 66 of any known type.

Although shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature may have been described above with respect to only one or more of several embodiments, such feature may be combined with one or more other features of the other embodiments, as may be desired and advantageous for any given or particular application.

1. A waveguide to parallel-plate transition, comprising:
a waveguide, an E-plane waveguide bend, an H-plane waveguide bend and a parallel-plate transmission line arranged in sequence, wherein:
the E-plane waveguide bend is configured to bend a direction of a radio frequency (RF) field between the waveguide and the H-plane waveguide bend by approximately 90 degrees in an E-plane,
the H-plane waveguide bend is configured to bend a direction the RF field between the E-plane waveguide bend and the parallel-plate transmission line by approximately 90 degrees in an H-plane, and
the parallel-plate transmission line includes a slot through which the RF field can flow between the H-plane waveguide bend and the parallel-plate transmission line.

2. The waveguide to parallel-plate transition according to claim 1, wherein the waveguide is aligned parallel to the parallel-plate transmission line.

3. The waveguide to parallel-plate transition according to claim 1, further comprising a waveguide tuning network interposed between the waveguide and the E-plane waveguide bend.

4. The waveguide to parallel-plate transition according to claim 3, wherein the waveguide tuning network includes a step in a broadwall dimension and a step in a narrow wall dimension of the waveguide.

5. The waveguide to parallel-plate transition according to claim 3, wherein the waveguide tuning network includes a circular waveguide stub in a wall of the waveguide.

6. The waveguide to parallel-plate transition according to claim 1, wherein the E-plane waveguide bend comprises at least one chamfer in a waveguide broad wall.

7. The waveguide to parallel-plate transition according to claim 1, wherein the H-plane waveguide bend comprises at least one step along a waveguide narrow wall.

8. A device, comprising:
at least two waveguide to parallel-plate transitions according to claim 1, each including the same parallel plate transmission line,
wherein the parallel-plate transitions are arranged with the waveguide of each of the at least two waveguide to parallel-plate transitions parallel to one another.

9. The device according to claim 8, wherein the waveguide of each of the at least two waveguide to parallel-plate transitions are aligned parallel to the parallel-plate transmission line.

10. A device, comprising:
at least two waveguide to parallel-plate transitions according to claim 1; and
at least one “Y”-shaped waveguide arranged to join together the waveguides of each of the at least two waveguide to parallel-plate transitions.
